(19) United States
(12) Patent Application Publication
(10) Pub. No.: US 2014/0245166 A1
(43) Pub. Date: Aug. 28, 2014

(54) ARTWORK ECOSYSTEM

(71) Applicant: Cameron Morton, Pleasanton, CA (US)

(72) Inventor: Cameron Morton, Pleasanton, CA (US)

(21) Appl. No.: 14/187,239

(22) Filed: Feb. 22, 2014

Related U.S. Application Data
(60) Provisional application No. 61/768,268, filed on Feb. 22, 2013.

(51) Int. Cl. G06F 3/0482; H04L 29/06

(52) U.S. Cl. CPC G06F 3/0482; H04L 63/20
USPC 715/743; 715/811

(57) ABSTRACT

A computer-implemented method performed at a computer system including one or more processors and memory storing one or more programs for execution by the one or more processors, wherein the computer system hosts a media management system. The computer system receives a selection of a media content item from a plurality of media content items stored on the computer system and an intended display device from a mobile computing device associated with a user of the media management system. The server then transmits the selected media content item to a physical display device associated with the media management system for presentation.

### CROSS REFERENCE TO RELATED APPLICATIONS

This application claims the benefit of priority under 35 U.S.C. §119(e) of U.S. Provisional Patent Application Ser. No. 61/768,268, filed Feb. 22, 2013, which application is incorporated by reference herein in its entirety.

### TECHNICAL FIELD

The disclosed implementations relate generally to the field of media content management, and in particular to a system for collecting, managing, and displaying media content over a wide variety of devices.

### BACKGROUND

The rise of the computer age has resulted in the ability to convert media into a digital form. Once converted into digital form, users can share, copy, and transfer digital media more cheaply and conveniently than ever. This change has disrupted established methods for managing and distributing media content. For example, digital music is cheap and easy to store and copy.

Traditional media companies have struggled to respond to the changing landscape. As a result, new companies and services have begun to fill the needs and desires of consumers not met by traditional companies. For example, iTunes has had great success by allowing customers to buy and organize their digital media collections over the Internet. This music is then accessible to the user to enjoy when and where the user wishes. Services such as iTunes have only increased consumer desire for easier and more flexible ways to enjoy and share their media collections.

### DESCRIPTION OF THE DRAWINGS

Some implementations are illustrated by way of example and not limitation in the FIGS. of the accompanying drawings, in which:

FIG. 1 is a network diagram depicting a client-server system 100 that includes various functional components of a media management system 120 in accordance with some implementations.

FIG. 2 is a block diagram illustrating a client system 102 in accordance with some implementations.

FIG. 3 is a block diagrams illustrating a media management server system (FIG. 1, 120) in accordance with some implementations.

FIG. 4 illustrates an exemplary user interface 400 for a home page of a complete media ecosystem in which media works (e.g., images, art, video, etc.) are easily accessible to a user through a variety of areas and platforms as well as a search feature and a social feature, in accordance with some implementations.

FIG. 5 illustrates an exemplary user interface 500 for a frames area page 500 in accordance with some implementations.

FIG. 6 illustrates an exemplary user interface 600 for a frames area page 600 in accordance with some implementations.

FIG. 7 illustrates an exemplary user interface 700 for a galleries platform page 700 in accordance with some implementations.

FIG. 8 illustrates an exemplary user interface 800 for a creations platform page 800 in accordance with some implementations.

FIG. 9 illustrates an exemplary user interface 900 for a life apps area page 900 in accordance with some implementations.

FIGS. 10A and 10B are flow diagrams illustrating a process for controlling art in an art ecosystem that includes a server system, client systems, and one or more display devices (e.g., frames) in accordance with some implementations.

FIG. 11 is a flow diagram illustrating a process for automatically controlling and updating media presented in one or more display devices based on several factors in accordance with some implementations.

FIG. 12 is a flow diagram illustrating a process for automatically converting text to message images in accordance with some implementations.

FIG. 13 is a flow diagram illustrating a process for transmitting the live creation of a piece of artwork from the creator's device to a display device at a different location in accordance with some implementations.

Like reference numerals refer to corresponding parts throughout the drawings.

### DETAILED DESCRIPTION

The present disclosure describes methods, systems and computer program products for a complete ecosystem combining web Sites, mobile and other browser-capable user devices, and display devices such as frame display devices, entire walls, and other devices for displaying images. In the following description, for purposes of explanation, numerous specific details are set forth in order to provide a thorough understanding of the various aspects of different implementations. It will be evident, however, to one skilled in the art, that implementations can be practiced without all of the specific details and/or with variations permutations and combinations of the various features and elements described herein.

The algorithmic processes used to manage media ecosystem and deliver the media for display are implemented with a combination of hardware (e.g., computer processors and memory) and software (e.g., executable instructions) that is generally referred to herein as an item management module. Furthermore, the implementations that are presented herein are generally applicable to a wide variety and nature of applications and tasks.

In some implementations the media management server system allows users to input media content items into the system. Inputs may include paintings, drawings, photographs, video stills, video, audio recordings, animations, etc. (hereinafter collectively referred to as “media content” or “media content items). In some implementations media content is uploaded from a capture device such as a camera or scanner, or alternatively available on another website such as through social media, artist websites, or photography sites such as Snapfish.

In some implementations devices such as tablet and laptop or desktop computer run a browser to access the website associated with the media content management system, view the user's media collection, and manage the user's collection of content. The core system provides the engine that responds to user requests for managing content, which may include creating new media from existing content (e.g., creating a collage), searching for content, purchasing and downloading content into the user's collection, and assigning a piece of content to a particular display device. The frame devices are screens for displaying images managed by the media management system. Examples of frame devices include electronic picture frames hanging on walls (or the walls themselves), large billboard signs, electronic display devices such as monitors or digital picture frames or small table top frames. It should be noted that frames and display devices are used interchangeably in this application.

In some implementations a mobile device such as a smartphone may be used to control the display of images in the user's collection onto the user's collection of frames. In some implementations a specific application is installed on the smartphone or tablet for the specific purpose of communicating with the media management system.

In some implementations there are three different classifications for a user of the system. Public users are those who have not registered, but have limited rights, especially viewing rights, on the web site. Member users have registered with the site. Members have at least the same access as public users and some additional privileges that will be explained below. Friends are members who are designated by another member to have special access rights to content managed by the designating member where the special access rights are not granted to members who are not friends. A member may be designated as friends by more than one other member, and each member may designate more than one other member to be a friend.

In some implementations when a visitor enters the system, the system determines that they do not have member privileges and are given public access. The first page a visitor sees is the main profile page. The mail profile page is an introduction to the JOTL system. From the main page, a visitor may navigate to the main home page where publically-available images are accessible. Selecting an image from the main home page displays the image. In some implementations, the image may be displayed in a separate main image window. In some implementations the separate window may overlay the main home page. In an alternate implementation, the current window may display the selected image instead of the main home page with the ability to navigate back to the home page.

In some implementations a visitor may navigate to the JOTL store to view and purchase physical display devices and peripherals from either the main profile page or the main home page. From any page of the system, a visitor may navigate to the Accounts page to register for an account. Once registered, the visitor becomes a member and receives member privileges.

In some implementations a member is given a profile page that introduces the member to the community of users analogous to a social networking profile. The member controls the content for their profile page. In some implementations the profile page content is viewable by the public

In some implementations a member is also given a home page on which the member may collect, manipulate, and control the display of images in frames. Only other members may view the home page of another member. For each image collected on a member's home page, the member may control which types of users (e.g., friends, other members who are not friends) may perform specific functions (e.g., view, copy, and/or manipulate images) on the home page.

In some implementations when a member enters the system, they start at their member home page. A member can navigate to their profile page to change the content of their profile page. They can select an image already on their home page and view and/or operate on the image. In some implementations, the image may appear in a separate window. In some implementations the separate window overlays the member's home page.

In some implementations a member searches for profile and home pages of other members and navigate to another member's page. A member may also navigate to the main profile or home page. From the main home page or another member's home page, a member may post images from their member home page onto the main home page or another member's home page for which access to post images is granted. In some implementations posting an image to another's home page makes that image accessible to other users. A member may also collect images from other home pages where the home page and the images are accessible to that member. “Collecting” an image may result in the image being accessible from the collecting member's home page.

In some implementations each area includes one or more platforms. A platform defines a set of operations to perform with respect to accomplishing the kind of task associated with the area. Thus, the set of platforms is specific to the area. For example, the platforms of appearing, manual, calendar, queues, and holding for the Frames area control the selection and scheduling of images appearing in specific frames. Another example is that the Creations area includes platforms such as video capture, picture conversion, art creations, story factory, and animation. Each platform may perform operations on a set of one or more images.

In some implementations a search text box allows a user to search for images on the member's own page, main page, or other member's pages, and on the World Wide Web. A member's name may be entered to search for another member's home page.

In some implementations the images are displayed based a combination of selections including: identity and status of the viewer, category selection, search terms, area and platform selections, and access rights associated with the particular viewed page (main profile, main home page, member profile, member home page, friend profile page, friend home page, or own profile or home page).

In some implementations when a specific image is selected, the image is opened within a functional image overlay window where functional operations may be performed on the image. The functional operations that are supported in the overlay window depends on the area where the image is located, the user type (Public, Member, Friend), and the access controls specified for the source of the image, such as a main home page or a member's home page. Information about the image, such as creator, categorization, and access rights may be edited here as well.

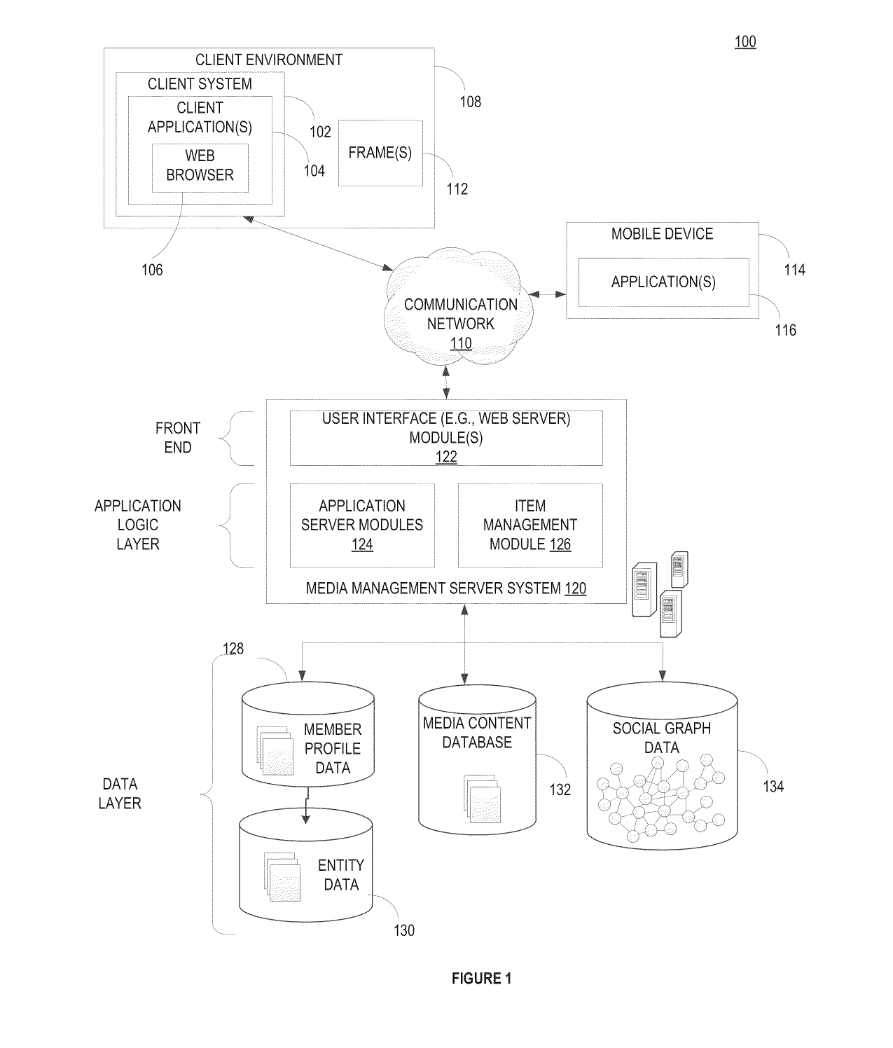

FIG. 1 is a network diagram depicting a client-server system 100 that includes various functional components of a media management server system 120 in accordance with some implementations. The client-server system 100 includes one or more client environments 102, a media management server system 120, and one or more mobile devices 114. One or more communications networks 110 interconnect these components. The communications network 110 may be any of a variety of network types, including local area networks (LAN), wide area networks (WAN), wireless networks, wired networks, the Internet, personal area networks (PAN) or a combination of such networks.

In some implementations a client environment 108 includes a client system 102. A client system 102 includes one or more client applications 104, which are executed by the client system 102. In some implementations the client application(s) 104 include one or more applications from the set consisting of search applications, communication applications, productivity applications, game applications, word processing applications, a media management application, or any other useful applications. In some implementations the client application(s) 104 include a web browser 106. The client system 102 uses the web browser 106 to communicate with the media management server system 120 and displays information received from the server system 120.

In some implementations the client system 102 sends a request to the media management server system 120 for a webpage associated with the media management server system 120 (e.g., the client system 102 sends a request to view art owned by the user of the client system 102 to the media management server system 120). For example, a user of the client system 102 logs onto the media management server system 120 and clicks to view a list of media (e.g., art, music, video, games, books) currently displayed at a device associated with the user (e.g., a frame 112, or other media presentation device owned by the user). In response, the client system 102 receives the list of media currently displayed at an electronic device associated with the user and displays the list on the client system 102.

In some implementations, as shown in FIG. 1, the media management server system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding have been omitted from FIG. 1. However, a skilled artisan will readily recognize that various additional functional modules and engines may be used with a media management server system 120, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, other configurations or architecture may be used to for the herein described implementations.

As shown in FIG. 1, the front end consists of a user interface module (e.g., a web server) 122, which receives requests from various client systems 102, and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser applications, or applications that have been developed for a specific platform to be used on any of a wide variety of mobile devices and operating systems.

As shown in FIG. 1, the data layer includes several databases, including databases for storing data for various entities of the media management server system 120, including member profile data 128, entity data 130 (e.g., data related to groups, corporations, galleries, and other entities registered with the media management server system 120), an media content database 134 (e.g., a database that includes all the media content items (e.g., video, images, art, music, eBooks, etc.) stored with the media management server system 120), and social graph data 136 (e.g., data concerning members relationships to each other). In some implementations the social graph data structure includes a graph database 136, which is a particular type of database that uses graph structures with nodes, edges, and properties to represent and store data. Of course, with various alternative implementations, any number of other entities might be included in the social graph (e.g., companies, organizations, schools and universities, religious groups, and any other group), and as such, various other databases may be used to store data corresponding with other entities.

Consistent with some implementations, when a person initially registers to become a member of the media management server system 120, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored, for example, in the member profile database 128.

Once registered, a member may invite other members, or be invited by other members, to connect via the media management server system 120. A “connection” may require a bi-lateral agreement by the members, such that both members acknowledge the establishment of the connection. Similarly, with some implementations, a member may elect to “follow” or “friend” another member. In contrast to establishing a “connection”, the concept of “following” another member typically is a unilateral operation, and at least with some implementations, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity, which may or may not be included in the social graph.

With some implementations, members may subscribe to or join groups affiliated with one or more companies, galleries, museums, etc. For instance, with some implementations, members of the media management server system 120 indicate an affiliation with a gallery to which they have a membership. Media content items (e.g., art) changes or updates associated with that gallery can then be automatically communicated to the members. With some implementations, members subscribe to receive information concerning particular companies, galleries, or museums.

In some implementations the application logic layer includes various application server modules 124, which, in conjunction with the user interface module(s) 122, generates various user interfaces (e.g., web pages) with data retrieved from various data sources in the data layer. With some implementations, individual application server modules 124 are used to implement the functionality associated with various applications, services and features of the media management server system 120. For instance, a messaging application, such as an email application, an instant messaging application, or some hybrid or variation of the two, may be implemented with one or more application server modules 124. Similarly, a search engine enabling users to search for and browse member profiles may be implemented with one or more application server modules 124. Of course, other applications or services that utilize the item management module 126 may be separately implemented in their own application server modules 124.

In addition to the various application server modules 124, the application logic layer includes the item management module 126. As illustrated in FIG. 1, with some implementations the item management module 126 is implemented as a service that operates in conjunction with various application server modules 124. For instance, any number of individual application server modules 124 can invoke the functionality of the item management module 126, to include an application server module associated with a messaging application and/or an application server module associated with an application to facilitate the viewing of member profiles or member associated media. However, with various alternative implementations, the item management module 126 may be implemented as its own application server module such that it operates as a stand-alone application. With some implementations, the item management module 126 includes or has an associated publicly available application programming interface (API) that enables third-party applications to invoke the functionality of the item management module 126.

Generally, the item management module 126 provides web pages to client systems 102 regarding information stored in or associated with member profiles 128. For example, a user can request a list of images associated with a member profile (e.g., click on UI button for displaying artwork owned by a particular user or member). The item management module 126 will then use the member profile data 128 and the media content database 132 to identify all the media assets that match the user request. The item management module 126 then returns the identified list of media content items to requesting client system 102 for display to a user. In another example, the client system 102 requests to view media content items with another user of the media management server system 120. The media management server system 120 uses the social graph data 134 and the media content database to determine whether the requesting user is authorized (e.g., by the owner of the requested media content item) to view them (e.g., whether the requested user is connected to the requesting user and has marked the requested media content items as public). If the media management server system (FIG. 1, 120) determines that the requesting user is authorized (e.g., the requestor has permission to access the request media content items) then media management server system 120 return the requested list of media content items associated with the other user.

In some implementations, the item management module 126 also receives requests from either a mobile device 114 or a client system 102 to cause a particular piece of media stored in the media content database 132 to be displayed in a frame 112 associated with the media management server system 120 (e.g., a frame connected media management server system 120 and associated with a user of the media management server system 120). For example, the item management module 126 receives a request from a mobile device 114 to change the display in a first frame 112 from a first image to a second image. The item management module 126 determines whether the requesting mobile device 114 has permission to change the image at the requested frame 112 and, in accordance with a determination that the mobile device 114 has the necessary permissions, the item management module 126 transmits the second image to the requested frame. In some implementations a request is from a first user and directed to a frame owned by the first user. In some implementations the request is from a first user and is directed to a frame not associated with the first user (e.g., for a user other than the first user).

In some implementations the item management module 126 receives media content items from a client system 102, a mobile device 114, or a third party website. The item management module 126 then associates the received media content items with the appropriate member profile (e.g., the user who transmitted the media content items) and stores the received media content items in the media content database 132. In some implementations the media content items are created at the client system (e.g., a piece of art or a movie is created by a user at the client system 102) and then transmitted to the item management module 126 for stored in the media content database 132

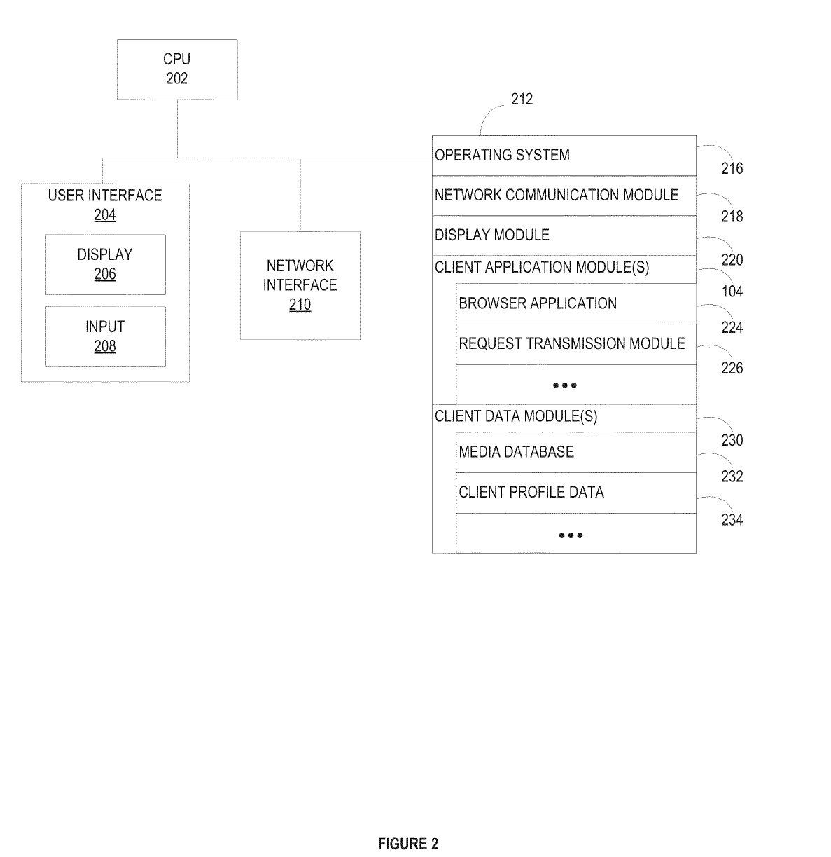

FIG. 2 is a block diagram illustrating a client system 102 in accordance with some implementations. The client system 102 typically includes one or more processing units (CPU's) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems use a microphone and voice recognition to supplement or replace the keyboard.

Memory 212 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, comprises a non-transitory computer readable storage medium.

In some implementations, memory 212 or the computer readable storage medium of memory 212 stores the following programs, modules and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks, such as the Internet, other wide area networks, local area networks, metropolitan area networks, etc.;
a display module 220 for enabling the information generated by the operating system 216 and client applications 230 to be presented visually on the display 206;
one or more client application modules 104 for handling various aspects of interacting with the server system 120, including but not limited to:
   a browser application 224 for requesting information from the server system 120 (e.g., product pages and user information) and receiving the response from the server system 120; and
   an request transmission module 224 for sending requests to display a particular piece of media at a particular frame associated with the media management server system (FIG. 1, 120); and
a client data module 230, for storing data relevant to the clients, including but not limited to:
   a media database 230 for storing media items (e.g., videos, images, audio files. Etc.) associated with the client system 102 (e.g., in a local cache); and
   client profile data 234.for storing profile data related to a user of the media management server system 120 associated with the client system 102.

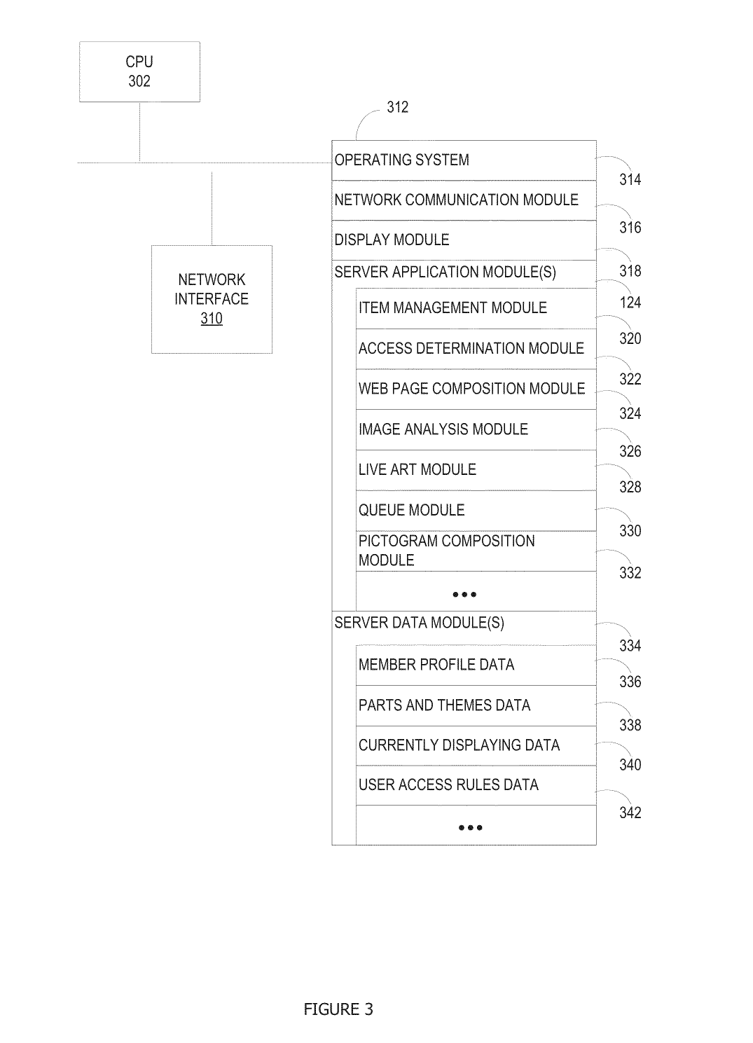

FIG. 3 is a block diagram illustrating a media management server system (FIG. 1, 120). The query server system 120 typically includes one or more processing units (CPU's) 302, one or more interfaces 310, memory 312, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 312, or alternately the non-volatile memory device(s) within memory 312, comprises a non-transitory computer readable storage medium. In some implementations, memory 312 or the computer readable storage medium of memory 306 stores the following programs, modules and data structures, or a subset thereof:
an operating system 314 that includes procedures for handling various basic system services and for performing hardware dependent tasks;
a network communication module 316 that is used for connecting the media management server system 120 to other computers via the one or more communication network interfaces 310 (wired or wireless) and one or more communication networks, such as the Internet, other wide area networks, local area networks, metropolitan area networks, and so on;
one or more server application modules 124 for performing the services offered by media management server system 120, including but not limited to:
   an item management module 320 for sending and receiving media content items from and to client systems and display devices (e.g., frames) as needed and presenting information related to organizing a user's media content collection through a website;
   an access determination module 322 for determining, based on user access rules, whether a particular user is authorized to view and/or change media content currently being presented at a particular display device;
   a web page composition module 324 for dynamically creating web pages for users based on the specific user request and the items to which the user has access;
   an image analysis module 326 for analysing existing images to identify and extract useful components, themes and templates for later use;
   a live art module 328 for receiving, in real time, actions taken by an artist to create an painting or an image and relaying them, in real time, to a second display device for viewing in real time;
   a queue module 330 for determining, based on a schedule received from a user, whether the media content item presented at a given display device needs to be changed and if so, automatically determining the media content item that should be presented and transmitting the determined item to the appropriate display device; and
   a pictogram composition module 332 for translating a text based message into an informative pictogram using the parts and themes data 338 stored at the media management server system, 120;
server data modules 334, holding data related to the media management server system (FIG. 1, 120), including but not limited to:
   member profile data 336 including data concerning user demographic information, user interests, user owned media content items, display devices associated with users, user social graph data, user queue information, user location data (e.g., based on GPS data), and any other relevant user data;
   parts and themes data 336 including images, parts of images, templates and theme data extracted from other media content items;
   currently displaying data 340 including data indicating what media content item is currently displayed at each display device; and
   user access rules data 342 including data for each respective display regarding which users, at what times, can change the currently display media content item at the display device.

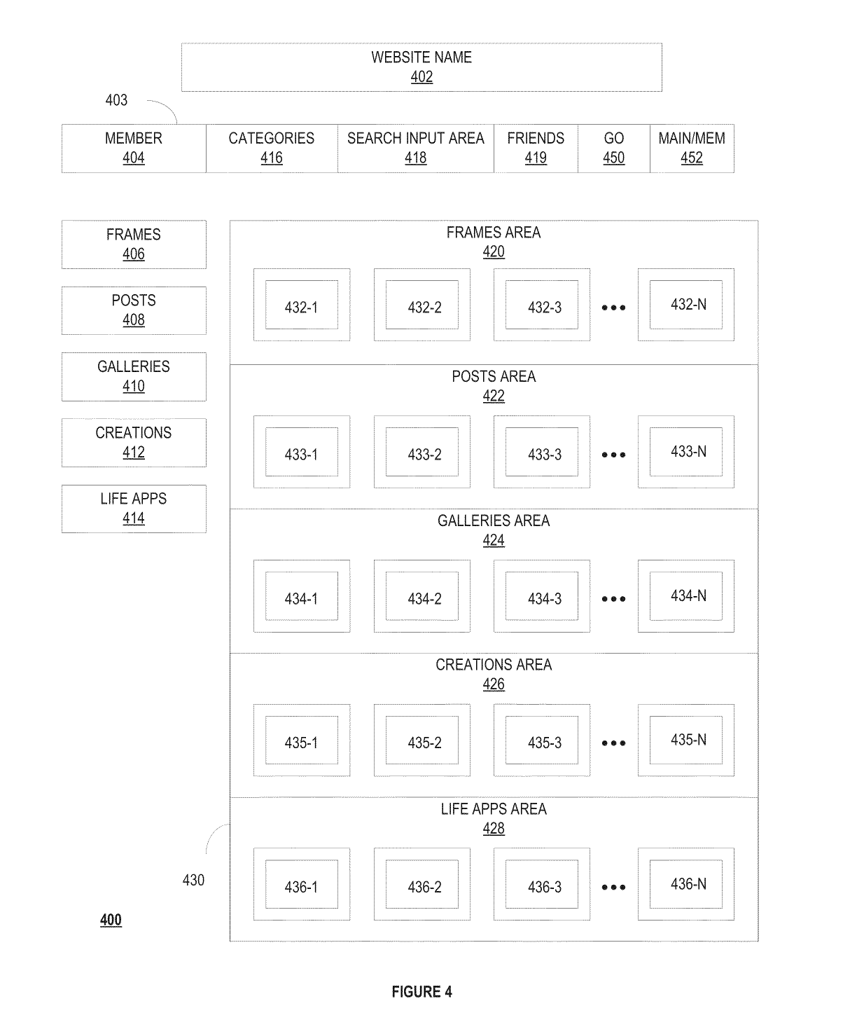

FIG. 4 illustrates an exemplary user interface 400 for a home page of a complete media ecosystem in which media content items (e.g., images, art, video, etc.) are easily accessible to a user through a variety of areas and platforms as well as a search feature and a social feature. In this example the user interface 400 includes a title bar 402 that displays the name of the website (e.g., Jotl or another website name). Below the website title bar 402 is the website navigation bar 403 that allows a user to quickly navigate from the home page to content matching an inputted search query. The website navigation bar 403 includes a member section button 404, a categories section 416, a search input area 418, and a friends section button 419.

In some implementations the member section button 404 displays the name of the user currently logged into the website. In some implementations, when no user is current logged on, the member section button 404 displays a “login button” and when selected the “login button” causes a login page to be displayed. When the member section button 404 is selected, a user profile page containing basic information about the user is displayed, including, but not limited to the user name, user contact information (e.g., e-mail address), a list of any physical display devices (e.g., frames) associated with the user profile, and at least some of the media content associated with the user profile (e.g., at least one piece of art).

In some implementations when the user selects the categories selection button 416, a drop down menu is displayed, the drop down menu containing a list of media content categories. In some implementations the categories are established by the media management server system (FIG. 1, 120). For example, the media management server system (FIG. 1, 120) may have pre-established categories such as “movies,” “trailers,” “art,” “Disney,” or any other category. In another example, a user may define categories and then assign pieces of media content to those categories. In some implementations each piece of media content has associated category information. Associated category information includes information about the type of media and the characteristics of the media (e.g., title, creators name, data of creation, genre, etc.). Once a media content item has associated category information a user can create a new category and define the associated category information as associated with the new category. In some implementations the media management server system (FIG. 1, 120) automatically determines which media content items match the user defined category. For example, a user can create a new category called “Post-Modern Mexican Surrealist Art.” The user can then define that the associated category information includes media content of type “art,” that originates in “Mexico,” after 1950 and includes the label “surrealist.” The media management server system (FIG. 1, 120) can then determine which media content items match this newly created category and display them when that newly created category is selected.

In some implementations the search input area 418 allows the user to enter a search query. The media management server system (FIG. 1, 120) then uses standard search techniques to find media content items that match the search query and return them for display to the user.

In some implementations when the friends selection button 419 is selected the page displays at least some users who are connected to the logged in user. In some implementations only directly connected friends are displayed. In other implementations additional users, such as second or third degree contacts, can also be displayed. In some implementations media content items belonging to each friend can be displayed in the friend page.

In some implementations when the GO button 450 is pressed it causes a selected friend's profile page to be displayed. Similarly, when the Main/Mem 452 is pressed it causes the main home page or specified member's profile page to be displayed.

In some implementations the user interface 400 also includes a left hand navigation bar. The left hand navigation bar includes several navigation buttons, including frames 406, posts 408, galleries 410, creations 412, and life apps 414. Each navigation button, when selected, will lead to display of a particular set of applications and media content (e.g., an area). In some implementations the user interface 400 includes a content display area 430. Prior to selection of a left-hand navigation button, the content display area 430 defaults to displaying at least some media content items from one or more different platforms. For example, some selected images from the frames area are display in the frames platform 420 and some selected images from the galleries area are displayed in the galleries area 424.

In some implementations the content display area 430 includes a plurality of sub-areas. In the current example, the user interface includes a frames area 420, a posts area 422, a galleries area 424, a creations area 426, and a life apps area 428. Each sub area includes one or more media content items (432-1-432-N). Furthermore each sub area can be side-scrolled to reveal additional media content items.

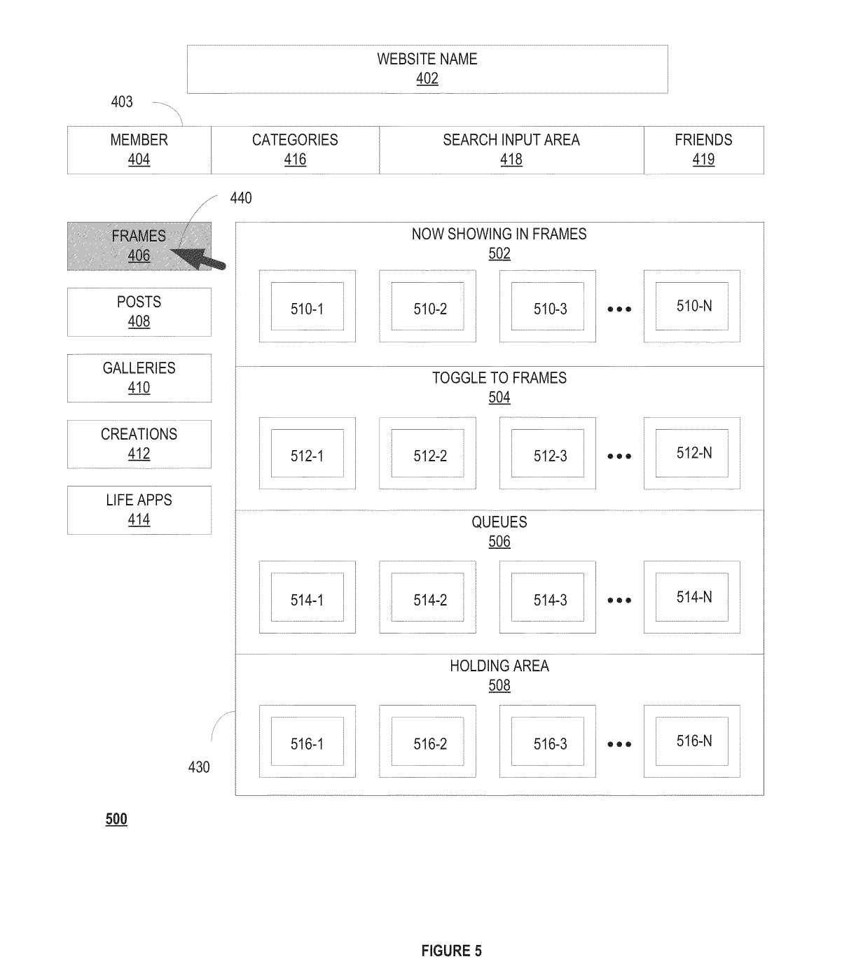

FIG. 5 illustrates an exemplary user interface 500 for a frames area page 500. In this example, as in FIG. 4, the user interface 500 includes a title bar 402, a website navigation bar 403, a content display area 430, and left hand navigation bar, and the user has selected the Frames selection button 406 from the left-hand navigation bar. In response the content display area 430 displays several new sub-areas related to the frames area. The new sub-areas include “Now Showing” 502, “toggle” 504, “Queues” 506, and “Holding Area” 508.

In some implementations the “Now Showing” 502 sub-area includes a visual depiction of the media content item current displayed in each of the physical displays associated with the present user. Thus, for each physical display that is associated with the user, there is at least one image 510 in the “Now Showing” 502 sub-area that depicts the content current displayed there. For example, if a user has 4 E-paper frames at home and one back-lit frame at work, the “Now Showing” sub-area 502 will display a representation of the content presented in all 5 frames (510-1 to 510-N). In some implementations there are enough current associated physical displays (e.g., frames) that they cannot all be shown simultaneously in the “Now Showing” sub area 502 and a user mush side-scroll to seem them all. In some implementations the “Now Showing” sub-area 502 can also be used to show the content currently displayed in the physical display devices of one or more friends.

In some implementations the “Toggle” sub-area 504 displays media content items (e.g., 512-1 to 512-N) that may be selected to be presented in a physical frame. The user selects one of the media content items and selects a target physical display (e.g., frame) and the selected media content item is then immediate presented in the selected physical frame. In some implementations a first user can select a media content item in their collection for display in a second user's physical display. However, the media management server system (FIG. 1, 120) first determines whether the second user has given permission for the first user to change the presented media content item in the physical display. In some implementations a first user can restrict which users, at what times, and what content may be selected for presentation in a physical display by a second user. For example, User A selects a frame in their house and allows their friends to change the presented media content item during the hours of 9 AM to 5 PM but restricts the content type to still images. Thus, a toggle command (to change the presented media) will be rejected if the sending user is not a friend of User A, the request was not within the specified time, or the requested media content item is not a still image (e.g., if the request was for a film).

In some implementations when the user selects the Toggle sub-area, the system displays the option of changing the media content item on one or more physical display devices. However, only display devices on which the user is authorized to change media content are displayed.

In some implementations the “Queues” sub-area displays media content items (e.g., 514-1 to 514-N) that have been pre-scheduled by a user to be presented on one or more physical displays when certain conditions is met. For example, a user can instruct the media management server system (FIG. 1, 120) to display certain Christmas themed media content items starting on December 10th and continuing until January 3rd of every year. Then when the media management server system (FIG. 1, 120) determines that the conditions have been met (in this case that the current date falls within December 10th and January 3rd) the system displays the designated art in accordance with the pre-arranged wishes of the user. In some implementations a user need only request that Christmas theme media content items are displayed and the media management server system (FIG. 1, 120) will, based on category information associated with the media content items, automatically select appropriate media to be presented. In some implementations a user can use any number of factors to determine when the presented media content item changes, including, but not limited to the date, the time, weather, current events (e.g., local sports team winning a game), the temperature, the occupants of a given room (e.g., using cell phone signals to identify which users are near a particular physical display and presenting customized media content), holidays, and any other relevant information.

In some implementations the “Holding” sub-area 508 displays media content items (e.g., 514-1 to 514-N) that are owned by the user but not currently assigned to another sub-area. The media content items stored in this sub-area can be moved later to one of the other sub-areas as the need arises.

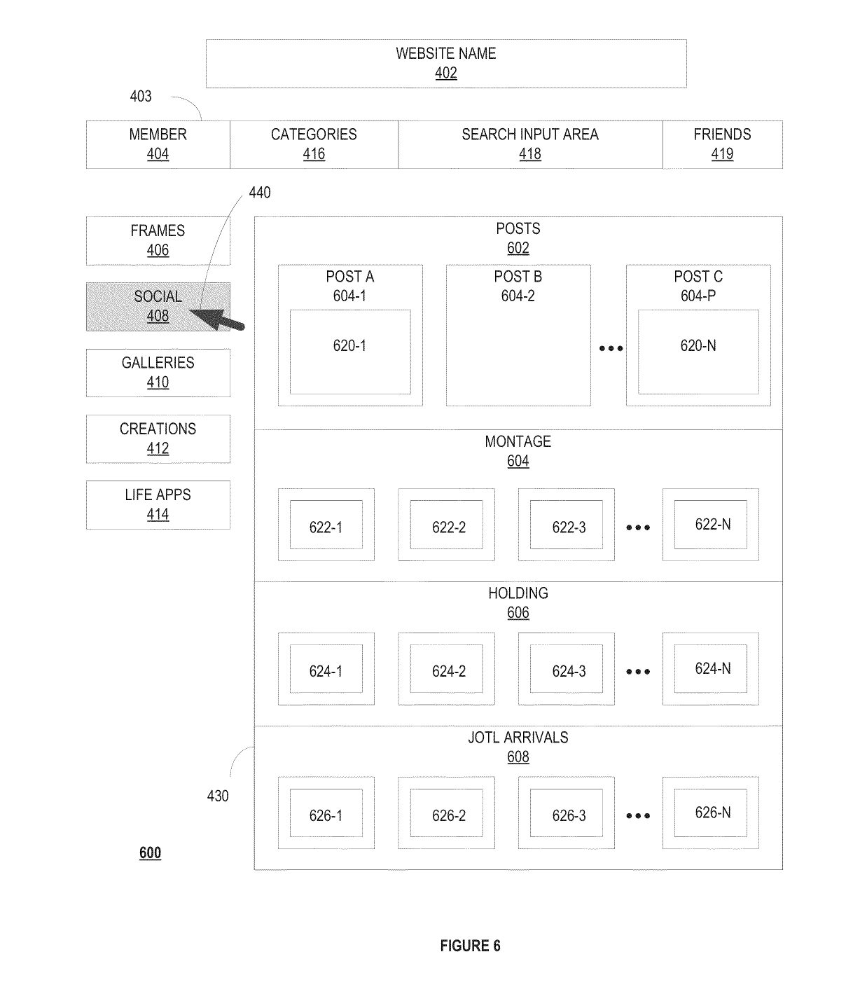

FIG. 6 illustrates an exemplary user interface 600 for a frames platform page 600. In this example, as in FIG. 4, the user interface 600 includes a title bar 402, a website navigation bar 403, a content display area 430, and a left hand navigation bar, and the user has selected the “Social” selection button 408 from the left-hand navigation bar. In response the content display area 430 displays several new sub-areas related to the “Social” platform. The new sub-areas include “Posts” 602, “Montage” 604, “Holding” 606, and “Jotl Arrivals” 608.

In some implementations the “Posts” sub-area 602 includes one or more social posts (604-1 to 604-P). Each social post has a post source (e.g., the user that posted the post). Some posts also have a post target (e.g., the user to whom the post is directed). In addition, some posts also include a media content item (620-1 to 620-N). For a given user the posts subarea 602 includes one or more of the user's own posts, the posts of friends of the user, and posts that are popular on the system as a whole. For example, user A clicks 440 on the social button 408 and views the “Posts” sub-area 602. The “Posts” sub-area includes a recent post from User A, several posts from friends of User A, and popular post from New York Gallery of Art.

In some implementations the “Posts” sub-area 602 includes one or more social posts (604-1 to 604-P). Each social post has a post source (e.g., the user that posted the post). Some posts also have a post target (e.g., the user to whom the post is directed). In addition, some posts also include a media content item (620-1 to 620-N). For a given user the posts sub-area 602 includes one or more of the user's own posts, the posts of friends of the user, and posts that are popular on the system as a whole. For example, user A clicks 440 on the social button 408 and views the “Posts” sub-area 602. The “Posts” sub-area includes a recent post from User A, several posts from friends of User A, and popular post from the New York Gallery of Art.

In some implementations the “Montage” sub-area 604 includes one or more montage posts (622-1 to 622-N). The “Montage” sub-area 604 allows users to work together and combine to make communal art projects (622-1 to 622-N). Contributing users can decide on a theme or allow the system to generate a theme. Montages can then be presented on a physical display device.

In some implementations the “Holding” sub-area 606 includes one or more media content items that can be used when a user is creating a post. In some implementations the “Jotl Arrivals” sub-area 608 is a staging area for media content items that are imported into the media management server system (FIG. 1, 120). Thus, when a user wants to import a media content item from a source outside the media management server system 120, the media content item will be displayed in the Jotl Arrivals sub-area 608. Thus, one or more of the most recently imported media content items (626-1 to 626-N) are displayed in the “Jotl Arrivals” sub-area 608. For example, the twenty most recently imported media content items are still displayed in the “Jotl Arrivals” sub-area 608.

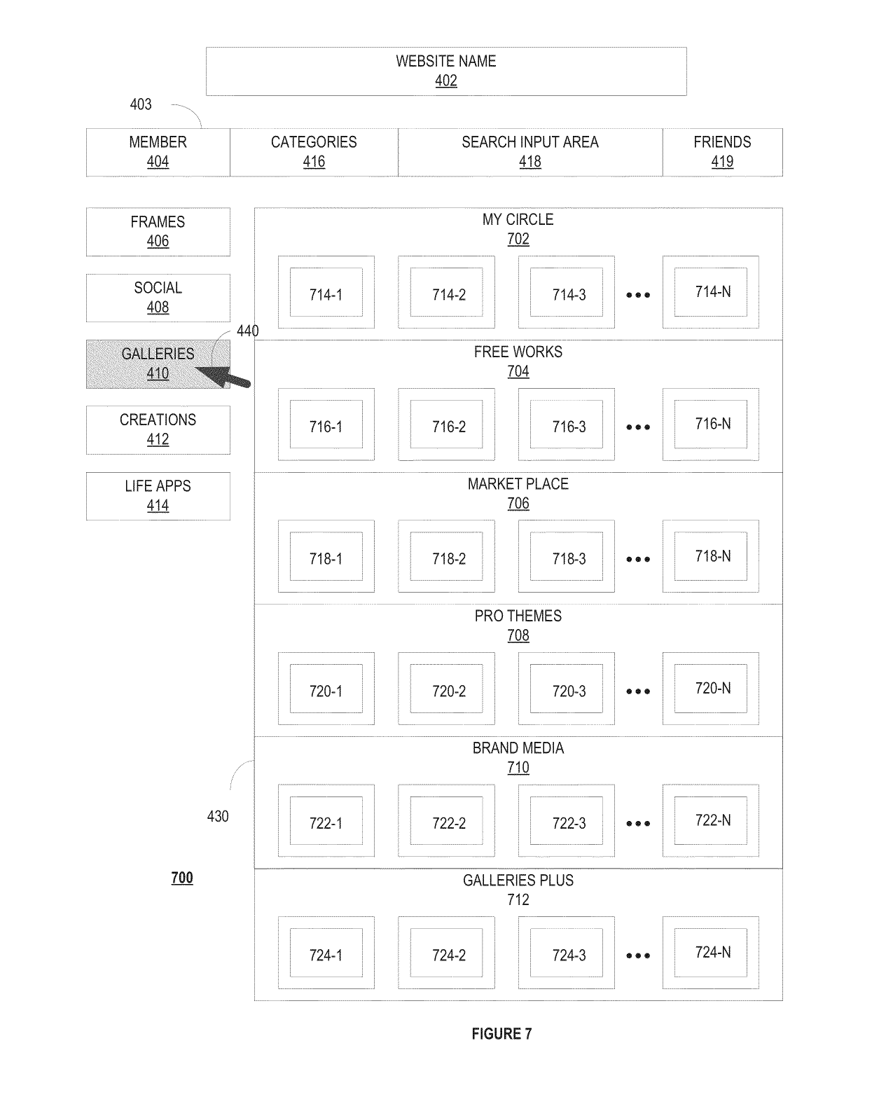

FIG. 7 illustrates an exemplary user interface 700 for a galleries area page 700. In this example, as in FIG. 4, the user interface 700 includes a title bar 402, a website navigation bar 403, a content display area 430, and a left hand navigation bar, and the user has selected 440 the “Galleries” selection button 408 from the left-hand navigation bar. In response the content display area 430 displays several new sub-areas related to the “Galleries” platform. The new sub-areas include “My Circle” 702, “Free Works” 704, “Market Place” 706, “Pro Themes” 708, “Brand Media” 710, and “Galleries Plus” 712.

In some implementations the “My Circle” sub-area 702 includes one or more depictions or representations of media content items (714-1 to 714-N). All the media content items represented in the “My Circle” sub-area 702 belong to friends and social contacts of the user (but not those of the user). For example, User A views the “My Circle” sub area 702. In the “My Circle” sub area 702 User A would be presented with depictions (e.g., screen shot or thumbnail image) of media content items owned by members of User A's friend circle.

In some implementations the “Free Works” sub-area 704 includes one or more depictions or representations of media content items (716-1 to 716-N). All the media content items represented in the “Free Works” sub-area 702 are made available on the media management server system (FIG. 1, 120) for free. In some implementations the free works are content items created by a user on the media management server system (FIG. 1, 120) and made free by the creator. In other implementations, the free works are media content items available from third party sources and imported into the media management server system (FIG. 1, 120). In some implementations free works includes both media content items created on the media management server system (FIG. 1, 120) and free content imported into the system.

In some implementations the “Market Place” sub-area 706 includes one or more depictions or representations of media content items (718-1 to 718-N). In some implementations the media content items (718-1 to 718-N) represented in the “Market Place” sub-area 706 are available for purchase. In other implementations the media content items (718-1 to 718-N) are media content items previously purchased by the user. In yet other implementations, media content items (718-1 to 718-N) are works commissioned by the user and created by other users of the media management server system (FIG. 1, 120).

In some implementations the “Pro Themes” sub-area 708 includes one or more depictions or representations of media content items (720-1 to 720-N). In some implementations professional creators of media content (e.g., artists) can sell their work through the “Pro-Themes” sub-area 708. Once purchased the media content is then displayed in the “Pro Themes” sub-area 708. In some implementations professionals can also offer services (commissioned work, tutoring, etc.) through the “Pro-Themes” sub-area 708. In some implementations the

In some implementations the “Brand Media” sub-area 710 includes one or more depictions or representations of media content items (722-1 to 722-N). In some implementations brands can offer media content items associated with their brand either free or at price. In some implementations users can virally share branded materials thought the media management server system's (FIG. 1, 120) social features.

In some implementations the “Galleries Additional” sub-area 712 includes one or more depictions or representations of media content items (724-1 to 724-N). This sub-area displays media content items for industry specific galleries, etc.

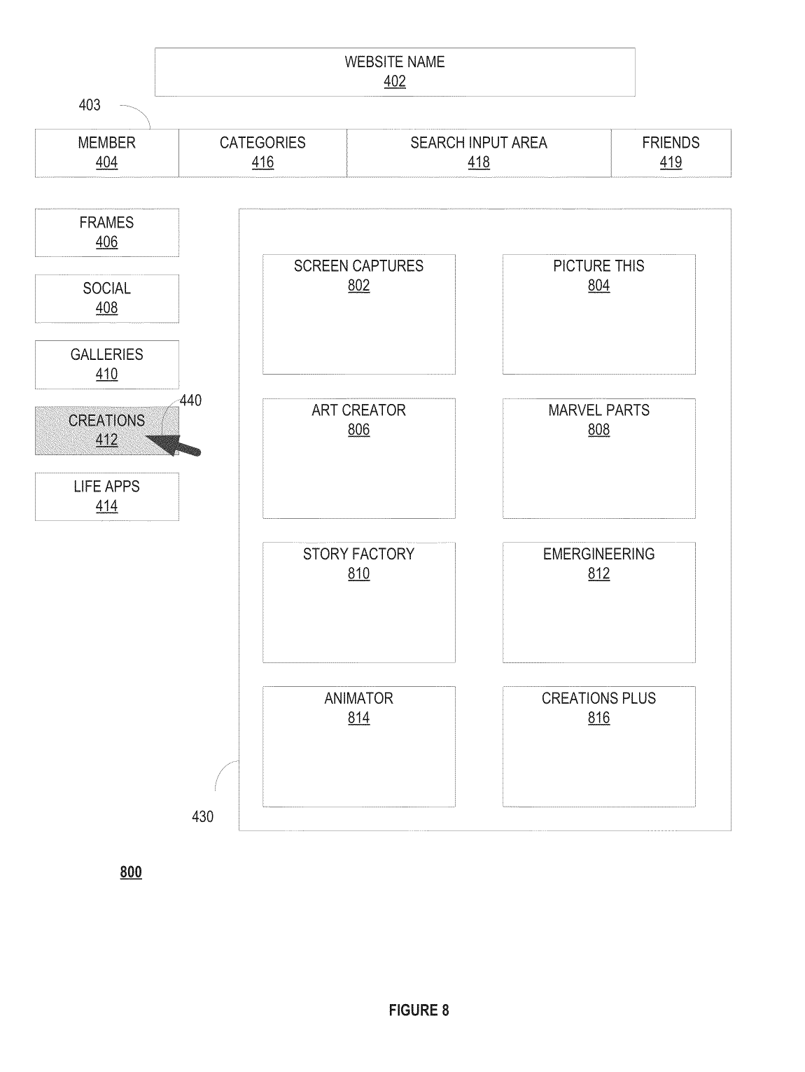

FIG. 8 illustrates an exemplary user interface 800 for a creations area page 800. In this example, as in FIG. 4, the user interface 800 includes a title bar 402, a website navigation bar 403, a content display area 430, and a left hand navigation bar, and the user has selected 440 the “Creations” selection button 412 from the left-hand navigation bar. In response to the selection button the content display area 430 displays several new mode sub-areas related to the “Creations” area. The new sub-areas include “Screen Captures” 802, “Picture This” 804, “Art Creator” 806, “Marvel Parts” 808, “Story Factory” 810, “Emergineering” 812, “Animator” 814, and “Creations Plus” 816.

In some implementations the “Screen Captures” sub-area 802 allows users to capture still images from a video presentation. The still images can then be used for presentation on a physical display. In some implementations the media management server system (FIG. 1, 120) allows the rights owner of the video content (e.g., copy right holder) to determine whether a particular user is able to capture a screen shot from a particular piece of video content. Thus, when a user attempts to capture a screen shot, the system first determines whether they have permission from the applicable rights holder.

In some implementations the “Picture This” sub-area 804 allows users to convert media content items from one visual appearance to another. For example, users can apply filters to images to give them the appearance of a well-age photo graph or a cartoon like appearance.

In some implementations the “Art Creator” sub-area 806 contains tools that allow users to create drawing and painting in a variety of styles and simulated mediums. These images can then be shared with other users or transmitted to physical devices for display. In some implementations the media management server system (FIG. 1, 120) stores the creation process for a piece of art, for later replay. For example, an artist uses a touch screen device to create a painting. Each “brushstroke” (e.g., a swipe or touch) is recorded. Later, if a user wishes to see the creation process, the system can replicate the creation process, stroke by stroke.

In some implementations the “Marvel Parts” sub-area 808 contains tools that allow users to analyse a media content item, identify specific parts and templates within the media, and save the parts and templates for later use. In some implementations the parts and templates can be used in conjunction with the “Art Creator” sub area 806 or the “Picture This” sub-area 804 for creating new images or works of art. For example, if the system analyses a family picture, it can identify each family member and create a separate image part file containing each family member separately. The user can then create new images with the individual family members rearranged or included in different scenes.

In some implementations the rights owners determine whether a given user is able to extract parts and templates from a given work. In some implementations the media management server system (FIG. 1, 120) determines whether a given user has permission to create parts or template prior to enabling the user to derive parts and templates from a media content item. In some implementations a user can share parts and templates with other users of the system. For example, if a user attempts to analyse a movie still, the system will ensure that they have the legal right to do so.

In some implementations the “Story Factory” sub-area 810 contains tools that allow users to create a series of images that convey or represent a story. In some implementations a user creates a group of images in a specific order in order to tell a story through the images. The created group of images has an associated flip frequency that determines how quickly each image is replace. In this way the group of story images functions like a slide show, graphic novel, a story board for a movie, or any other visual story format.

In some implementations the “Emergineering” sub-area 812 contains tools that allow users to determine how a media content item is displayed on a physical display. By default, a media content item is displayed all at once. For example, a painting is entirely rendered on a display effectively instantly. However, users can customize how a visual work emerges on a display. For example, once an image has been analysed to identify particular parts or templates, the user can choose to have each part displayed in a particular order, such that the image is displayed one piece at a time until the full media content item is presented. In some implementations the media content item contains creation data (e.g., data that outlines the creation of the media content). The media management server system (FIG. 1, 120) then can recreate the work in the same manner as it was created. For example, a child creates a painting for a parent using a touch sensitive electronic device. The device stores each finger touch and transmits it to the media management server system (FIG. 1, 120) along with the final painting. The parent can then choose to have the painting displayed based on each finger touch such that the presentation recreates the child's creation of the image.

In some implementations the “Animator” sub-area 814 contains tools that allow users to create animations from still images, templates, and parts. For example, a member of the media management server system (FIG. 1, 120) users a character part to create a series of still images with the character moving from one side of the frame to the other. The media management server system (FIG. 1, 120) then automatically converts the images to computer graphics and animates the frames into one continuous animation.

In some implementations the “Creations Plus” sub-area 816 includes tools that allow users to create animations from still images, templates, and parts determine how a media content item is displayed on a physical display.

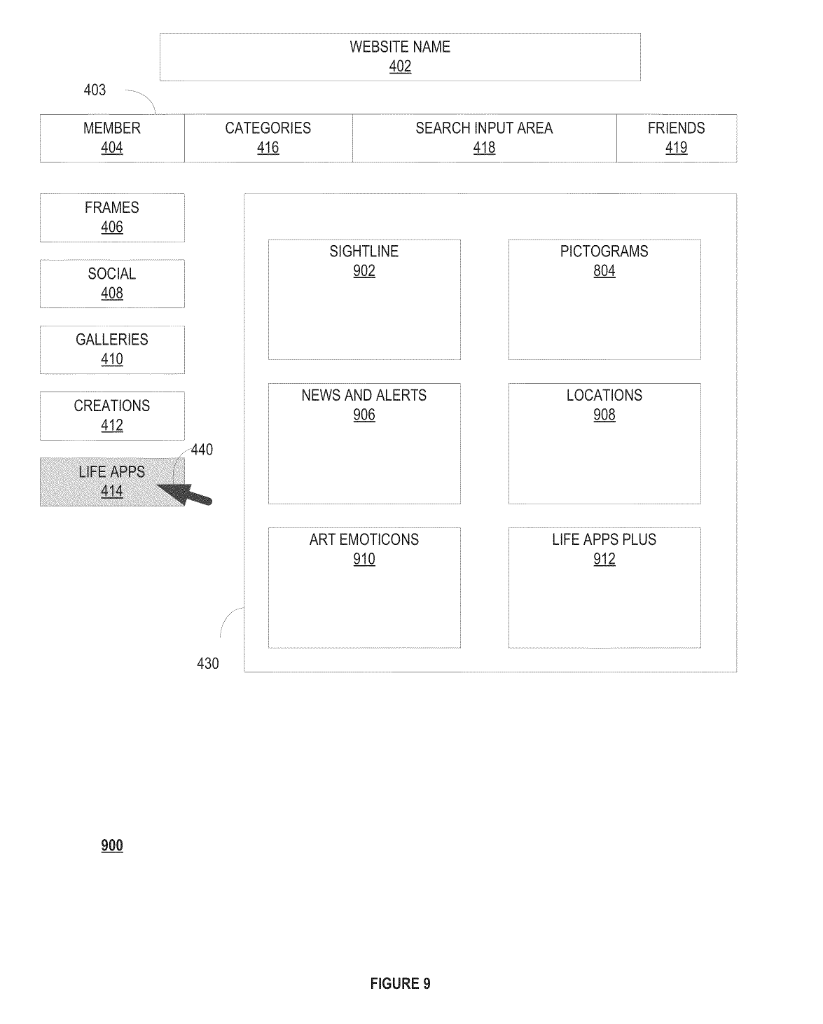

FIG. 9 illustrates an exemplary user interface 900 for a life apps area page 900. In this example, as in FIG. 4, the user interface 900 includes a title bar 402, a website navigation bar 403, a content display area 430, and a left hand navigation bar, and the user has selected 440 the “Life Apps” selection button 414 from the left-hand navigation bar. In response to selection of the selection button the content display area 430 displays several new mode sub-areas related to the “Life Apps” platform. The new sub-areas include “Sightline” 902, “Pictograms” 904, “News and Alerts” 906, “Locations” 908, “Art Emoticons” 910, and “Life Apps Plus” 912.

In some implementations the “Sightline” sub-area 902 includes tools that allow users to designate certain media content items that the user desires to frequently be displayed or available to them. In some implementations the media content includes images, text, quotations, religious messages, to do lists, goals, menus, calendar notifications. In some implementations the user can combine important text with backgrounds, schemes, and parts stored in the media management server system (FIG. 1, 120) to create important images. In some implementations the media management server system (FIG. 1, 120) has some ability to track user location (e.g., GPS sensors in a smart phone) and automatically present materials as a user moves nearer to different physical displays throughout the day. For example, a to do list is displayed at home as the user gets ready for work and when the media management server system (FIG. 1, 120) determines that the user has reached his or her office, the to do list is then presented in a frame at work. In some implementations a first user will leave arrive near a display owned by a second user of the system and, if the second user has set permissions to allow it, the system will display media content from the “Sightline” sub-area 902 while the first user remains near the second user's display.

In some implementations the “Pictograms” sub-area 904 includes tools that allow users to send visual messages to frames owned and controlled by other members. In some implementations a first user creates an image with a specific meaning (e.g., a happy birthday image) and sends it to a second user. In other implementations, the first user selects a type of message and the message content and the media management server system (FIG. 1, 120) automatically selects specific images to meet the first user's request and displays the created pictogram at a physical display in the proximity of the second user. In yet other implementations, the first user enter a text only message and the media management server system (FIG. 1, 120) automatically converts the text message to a pictogram that, when displayed to a second user, conveys the message of the original text message. For example, the first user enters the message “Hey Brad, let's meet at Rodigio's for lunch at 1:15 pm.” The media management server system (FIG. 1, 120) the selects appropriate imagery, such as a picture of the indicated restaurant and a clock showing the proposed time, creates a pictogram and presents the image at a physical display in the Proximity of the intended recipient, Brad.

In some implementations if the media management server system (FIG. 1, 120) determines that intended recipient is not near a physical display, the media management server system (FIG. 1, 120) will notify the sender and offer to deliver the message as an email or a text message.

In some implementations the “News and Alerts” sub-area 906 one or more media content items that are related to current news, weather, calendar reminders, announcements, and any topics the user has requested to be updated on. For example, the media management server system (FIG. 1, 120) monitors news feeds and generates images related to important news events. Then, for each generated image, the media management server system (FIG. 1, 120) determines one or more users whose explicit or implicit interest match the topic of the news alert. The media management server system (FIG. 1, 120) then provides the image to the determined user either for display on an allocated physical display or to be shown in the “New and Alerts” sub-area 906. In some implementations users can create and share their own includes tools that allow users to send visual messages to frames owned and news or alert related images in the “News and Alerts” sub-area 906.

In some implementations the “Locations” sub-area 908 includes tools that allow users to collect and assign images for user with GPS technology in electronic devices. Thus, as the user travels around, an image associated with their current location is updated. For example, user A has assigned a display at his home to reflect his current location. When he is a work, the display shows an image related to work. When he leaves work and goes to the gym, the image changes to an image assigned to the gym. In this way, his family can follow his location merely by viewing the image display on the assigned display. In some implementations a user can record the images assigned with their location over a certain period of time to create a travelogue slideshow for a given period of time.

In some implementations the “Art Emoticons” sub-area 910 includes tools that allow users to collect and assign various communication parts and characters to form a pictorial language (e.g., a method for communicating the relying in images rather than strictly on text.) This pictorial language can then be used to send and receive messages through the media management server system (FIG. 1, 120). In some implementations the “Life Apps Plus” sub-area 912 includes tools that extend the life apps features and tools for businesses and commercial ventures.

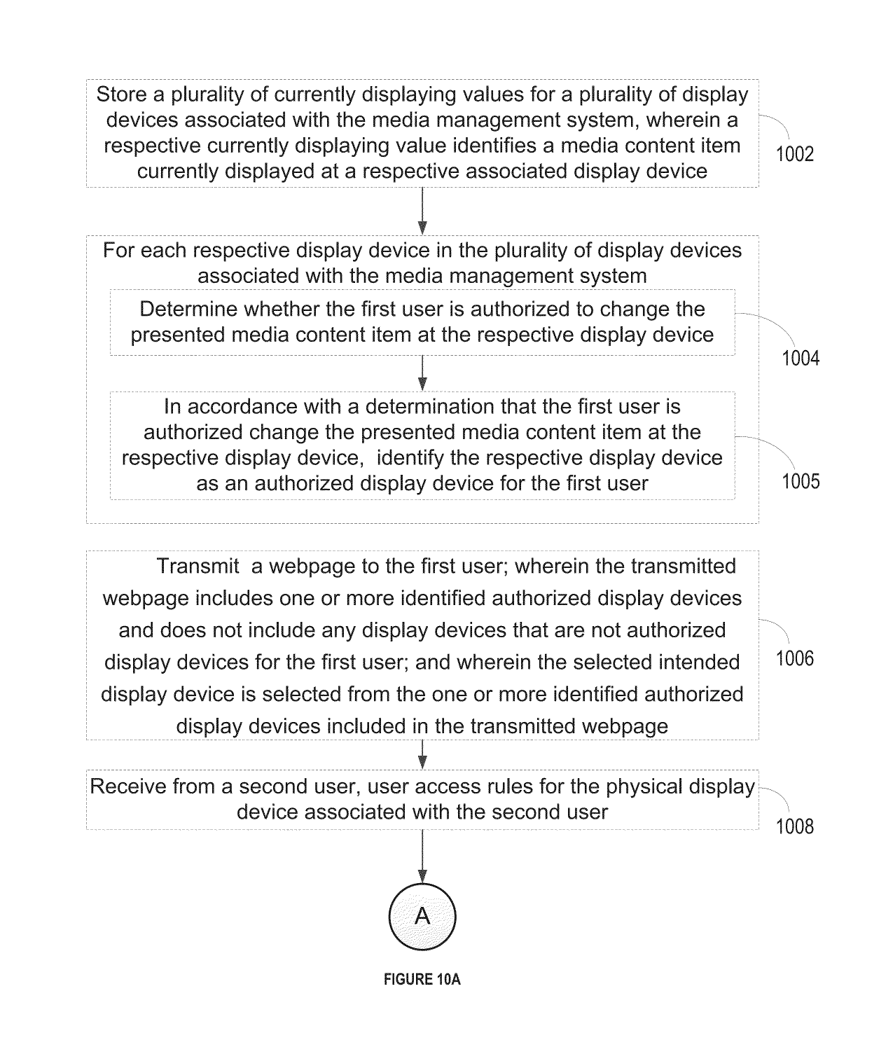

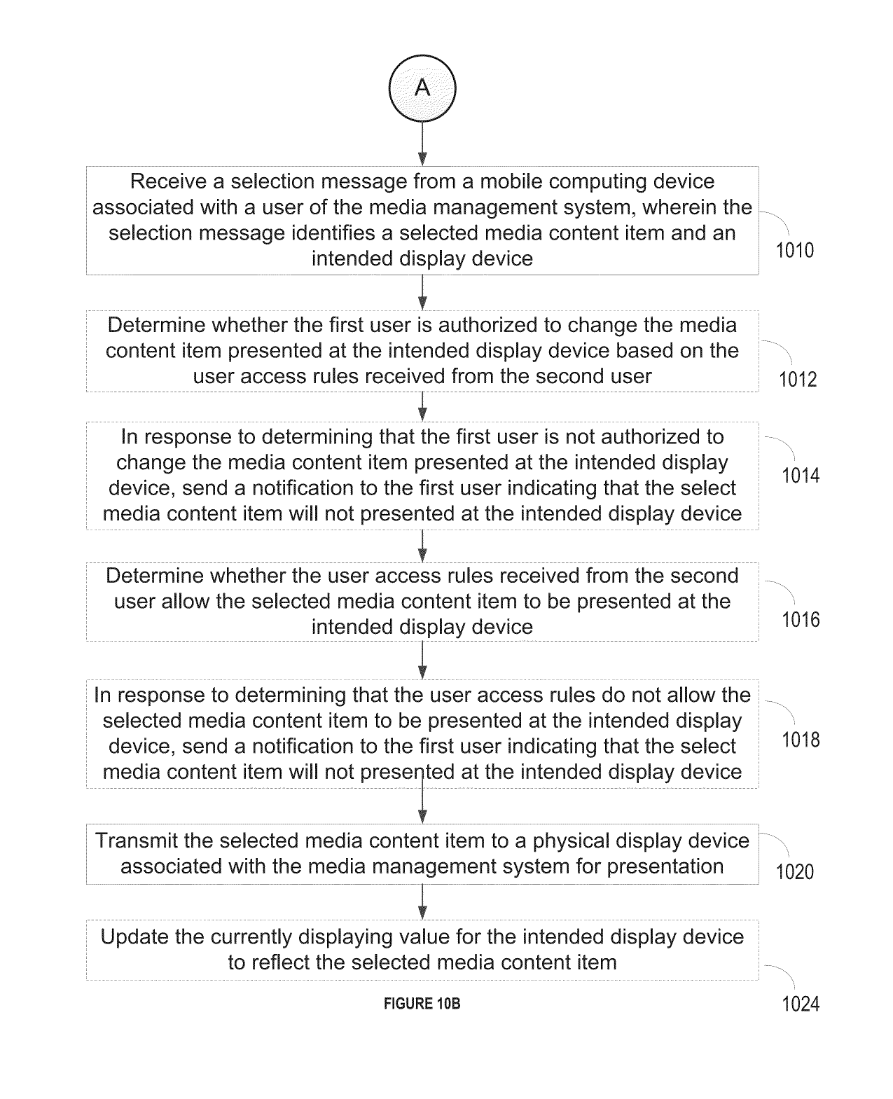

FIGS. 10A and 10B are flow diagrams illustrating a process for controlling art in an art ecosystem that includes a server system, client systems, and one or more display devices (e.g., frames) in accordance with some implementations. Each of the operations shown in FIGS. 10A and 10B may correspond to instructions stored in a computer memory or computer readable storage medium. Optional operations are indicated by dashed lines (e.g., boxes with dashed-line borders). In some implementations, the method described in FIGS. 10A and 10B is performed by the media management server system (FIG. 1, 120).

In some implementations the method is preformed at a computer system including one or more processors and memory storing one or more programs for execution by the one or more processors, wherein the computer system hosts a media management system. In some implementations the media management server system (FIG. 1, 120) tracks a plurality of display devices that are connected to or otherwise associated with the system such that the system can change or update the media content presented. In some implementations the connected display devices are produced by the same company, corporation, or entity that runs the media management server system (FIG. 1, 120). In some implementations each connected or associated display has a set of user access rules. User access rules are a set of guidelines established by users that determine control who can change the media content items currently displayed, when the media can be changed, and what type or kind of media content items can appear on a given display device. For example, User A has two physical display devices that are connected to the media management server system (FIG. 1, 120) Frame B (in the user's bedroom) and Frame C (in the user's living room). User A established that only he or she can change the media displayed in Frame B. User A also established that User D and User E can change the media presented in Frame C from 8 AM to 8 PM every night and can only display still images (e.g., no movies or animations). Thus, Users D and E can choose to change the media presented on Frame C only during the indicated time and only with a still image.

In some implementations the media management server system (FIG. 1, 120) stores (1002) a plurality of currently displaying values for a plurality of display devices associated with the media management system, wherein a respective currently displaying value identifies a media content item currently displayed at a respective associated display device. For example, for each frames of Frames A-Z, the system stores the name or other identifier for the presented media content item. This value is updated whenever the presented media content item is changed.

In some implementations the media management server system (FIG. 1, 120) receives a request for a media change web page from a client system (FIG. 1, 102). A media change web page is a webpage that includes tools and systems that allow a user to change the media content item currently presented at a display device. In some implementations, for each respective display device in the plurality of display devices associated with the media management system, the media management server system (FIG. 1, 120) determines (1004) whether the first user is authorized to change the presented media content item at the respective display device. In accordance with a determination that the first user is authorized change the presented media content item at the respective display device, the media management server system (FIG. 1, 120) identifies (1005) the respective display device as an authorized display device for the first user.

In some implementations, in response to a request for a media change webpage, the media management server system (FIG. 1, 120) transmits (1006) a webpage to the client system (FIG. 1, 102), wherein the webpage only lists display devices for which user of the device has permission to change the displayed media. For example, User A requests a media change webpage. The media management server system (FIG. 1, 120) determines that User A only has permission to change the media content item presented at Frames B and C (which are owned by User A) and Frame D (which is owned by User D). The media management server system (FIG. 1, 120) then transmits a media change webpage to User A that only lists Frames B, C, and D. In this way a user only sees frames they are eligible to change.

In some implementations the media management server system (FIG. 1, 120) receives (1008) user access rules for the physical display device associated with the second user from a second user.

In some implementations the media management server system (FIG. 1, 120) receives (1010) a selection of a media content item from a plurality of media content items stored on the computer system and an intended display device (e.g., a digital frame) from a mobile computing device (e.g., a smartphone or laptop computer) associated with a user of the media management system. In some implementations a media content item is one of an image, a video, text for display, an animation, or an audio recording. For example, a user wishes to change the image currently displayed in a digital frame on his wall that is connected to the media management server system (e.g., Jotl, etc.). Using a web browser or a dedicated application, the user logs into the media management server system (FIG. 1, 120) and browses all the media content items (e.g., images, videos, animations, etc.) that the user has access to. The user then selects a content item and indicates which display device to present the media content item at.

In some implementations, in response to receiving the selection of a media content item and an intended display device from a first user, the media management server system (FIG. 1, 120) determines (1012) whether the first user is authorized to change the media content item presented at the intended display device based on the user access rules received from the second user. For example, if the system receives a request from User A to change the content on Frame C, which is owned and controlled by User B, the system checks the user access rules previously submitted by user B to determine whether User A is authorized to change the media content at the time the request is submitted.

In some implementations, in response to determining that the first user is not authorized to change the media content item presented at the intended display device, the media management server system (FIG. 1, 120) sends (1014) a notification to the first user indicating that the select media content item will not be presented at the intended display device. For example, if User A requests to change the media at Frame B and the server determines User A is not authorized to change the media presented at frame B at this time, the system does not transmit the selected media content item to Frame B and instead sends a message to User A indicating that the selected media content item will not be displayed (e.g., “Sorry, you are not authorized to change the media content item presented on Frame B at this time.” In accordance with a determination that the user is authorized to change the media content item presented at the intended display device, the media management server system (FIG. 1, 120) transmits the selected media content item as discussed below.

In some implementations, in response to receiving the selection of a media content item and an intended display device from a first user, the media management server system (FIG. 1, 120) determines (1016) whether the user access rules received from the second user allow the selected media content item to be presented at the intended display device. For example, if the selected media content item is a video and the intended display device is Frame A, the media management server system (FIG. 1, 120) determines whether the user access rules allow a video to be presented on Frame A.

In some implementations in response to determining that the user access rules do not allow the selected media content item to be presented at the intended display device, the media management server system (FIG. 1, 120) sends (1018) a notification to the first user indicating that the select media content item will not be presented at the intended display device. Continuing the above example, if the media management server system (FIG. 1, 120) determines that the user access rules do not permit video to be presented at Frame A, the system does not transmit the selected media content item to Frame A and instead sends a message to User A indicating that the selected media content item will not be displayed (e.g., “Sorry, the selected Frame is not authorized to present videos.”)

In some implementations the media management server system (FIG. 1, 120) then transmits (1020) the selected media content item to a physical display device associated with the media management system for presentation. For example, a user has selected Image A and designated digital Frame B. The media management server system (FIG. 1, 120) then transmits image A to frame B. Frame B then stops displaying video C and begins to display image A.

In some implementations after transmitting the selected media content item to the intended display device for presentation, the media management server system (FIG. 1, 120) updates (1024) the currently displaying value for the intended display device to reflect the selected media content item.

In some implementations the physical display device is distinct from the mobile device associated with the first user. In some implementations the physical display device is a digital picture frame. In some implementations wherein the display device is an e-paper display. For example, the display device is a digital frame on the wall of the user's office and the mobile device is a smartphone that the user is using while at home.

In some implementations the physical display device is associated with a second user of the media management system. For example, User A is visiting User B's home. User A wants to show User B a painting that User A has recently purchased. As long as User B has a digital display capable of connecting to the media management server system (FIG. 1, 120) User A can use his smart phone or tablet to select the newly purchased image throughout the media management server system (FIG. 1, 120) and direct the system to display the newly purchased image on a frame owned by User B.

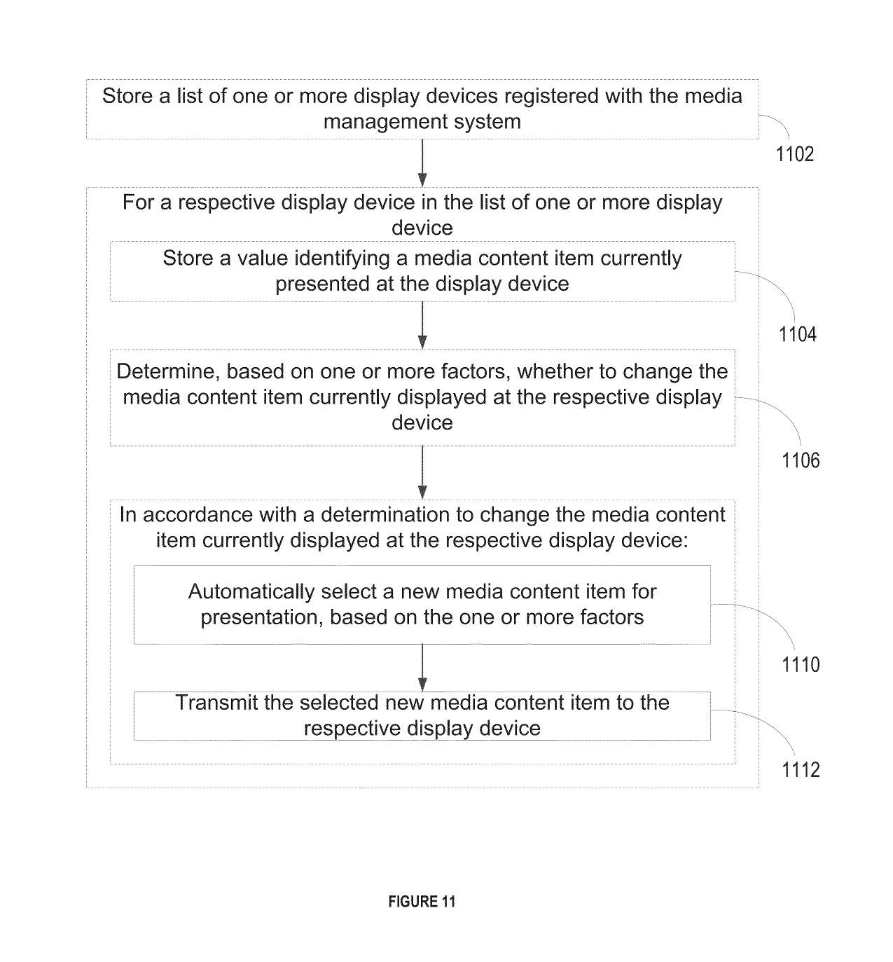

FIG. 11 is a flow diagram illustrating a process for automatically controlling and updating media presented in one or more display devices based on several factors in accordance with some implementations. Each of the operations shown in FIG. 11 may correspond to instructions stored in a computer memory or computer readable storage medium. Optional operations are indicated by dashed lines (e.g., boxes with dashed-line borders). In some implementations, the method described in FIG. 11 is performed by the media management server system (FIG. 1, 120).

In some implementations the method is performed at a computer system including one or more processors and memory storing one or more programs for execution by the one or more processors, wherein the computer system hosts a media management system. In some implementations the media management server system (FIG. 1, 120) stores (1102) a list of one or more display devices registered with the media management system.

In some implementations, for a respective display device in the list of one or more display device, the media management server system (FIG. 1, 120) stores (1104) a value (e.g., currently displaying value) representing the media content item currently presented at the display device.

In some implementations the media management server system (FIG. 1, 120) determines (1106), based on one or more factors, whether to change the media content item currently displayed at the respective display device. The one or more factors include, but are not limited to: the time of day, the date, the holiday or season, the weather or temperature, the amount of time that the previous media content item has been displayed, and which users of the media management server system (FIG. 1, 120) are in the vicinity of the display device. For example, Frame A has an associated rule that after 5 pm during the holiday season, the media management server system (FIG. 1, 120) should choose holiday themed artwork for display at Frame A. Thus, when the media management server system (FIG. 1, 120) determines that the time has passed 5 pm during the holiday season, the media management server system (FIG. 1, 120) determines that the media content item needs to be changed. In another example, Frame A has a rule that when User A and User B are both in the same room as Frame A (based on smartphone GPS, for example) the system should replace the currently displayed media content item with one from the group that both User A and User B enjoy.

In some implementations, in accordance with a determination to change the media content item currently displayed at the respective display device, the media management server system (FIG. 1, 120) automatically selects (1108) a new media content item for display, based on the one or more factors. For example, if the media management server system (FIG. 1, 120) determines that a holiday themed painting should be displayed, it automatically chooses an appropriate painting from those available.

In some implementations, the media management server system (FIG. 1, 120) transmits (1112) the selected new media content item to the respective display device. In some implementations, the media management server system (FIG. 1, 120) also updates the respective display device's currently displayed value to the new media content item.

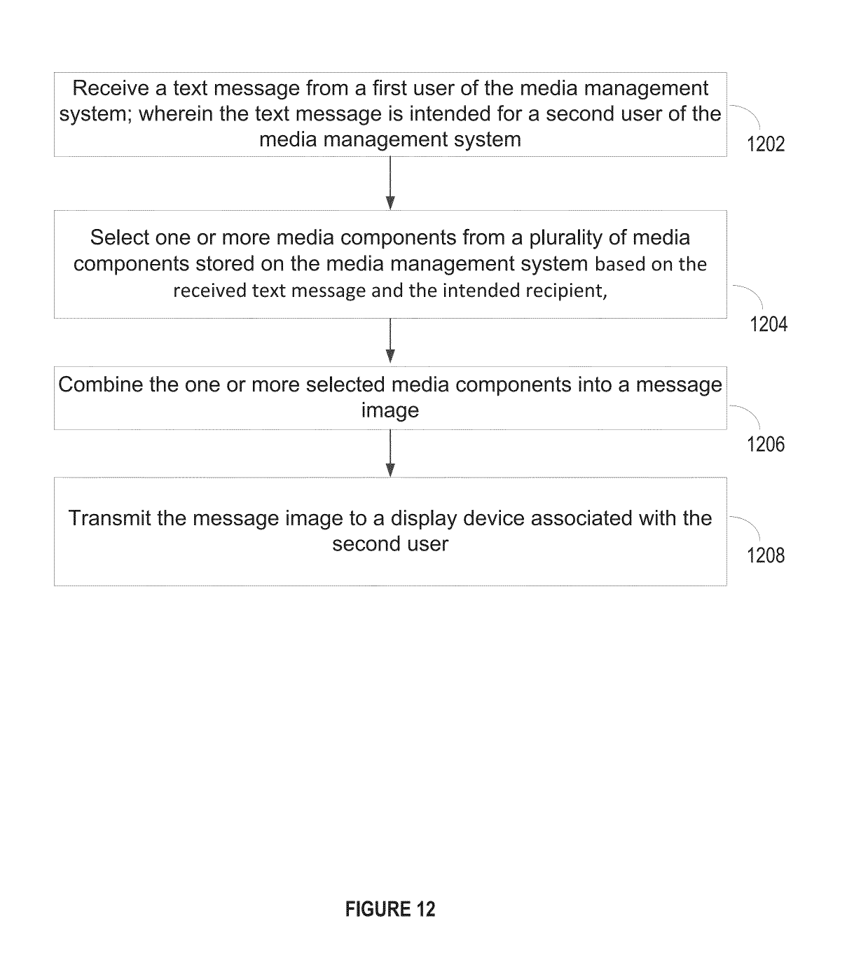

FIG. 12 is a flow diagram illustrating a process for automatically converting text to message images in accordance with some implementations. Each of the operations shown in FIG. 12 may correspond to instructions stored in a computer memory or computer readable storage medium. Optional operations are indicated by dashed lines (e.g., boxes with dashed-line borders). In some implementations, the method described in FIG. 12 is performed by the media management server system (FIG. 1, 120).

In some implementations the method is performed at a computer system including one or more processors and memory storing one or more programs for execution by the one or more processors, wherein the computer system hosts a media management system. In some implementations the media management server system (FIG. 1, 120) receives (1202) a text-based message from a first user of the media management system; wherein the text message is intended for a second user of the media management system. For example, the message may read “John, let's meet at 11:45 at Rodigio's for lunch.”

In some implementations, based on the received text message and the intended recipient, the media management server system (FIG. 1, 120) selects (1204) one or more media components from a plurality of media components stored on the media management system. In some implementations media components include full images, animations, image parts, themes, videos and video clips, and templates, along with any other whole or partial media component. For example, the media management server system (FIG. 1, 120) identifies a lunch appointment template from its template database.

In some implementations the media management server system (FIG. 1, 120) combines (1206) the one or more selected media components into a message image. Continuing the above example, after identifying a lunch appointment template and other media content items that indicate the Rodigio's restaurant and the time, the media management server system (FIG. 1, 120) creates a complete image that includes all the selected components in an easy to understand format.

In some implementations the media management server system (FIG. 1, 120) then transmits (1208) the message image to a display device associated with the second user. In some implementations the media management server system (FIG. 1, 120) determines the registered display device that is closest to the intended recipient of the message. The media management server system (FIG. 1, 120) then transmits the image to the determined closest display device. In some implementations if no display device is determined to be sufficiently close (e.g., in the same room as the intended recipient based on his smartphones GPS location) to the intended recipient the media management server system (FIG. 1, 120) instead transmits the message as text through e-mail, text message, or other messaging service. In some implementations if the media management server system (FIG. 1, 120) determines the intended recipient is not within a reasonable distance to a registered display device, the media management server system (FIG. 1, 120) notifies the sending user and prompts the user to select an alternative message transmission method.

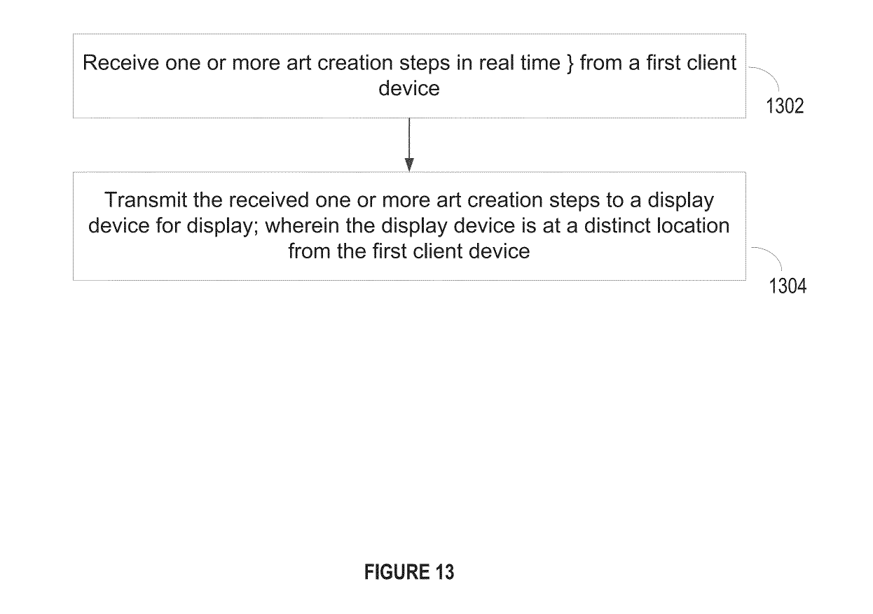

FIG. 13 is a flow diagram illustrating a process for transmitting the live creation of a piece of artwork from the creator's device to a display device at a different location in accordance with some implementations. Each of the operations shown in FIG. 13 may correspond to instructions stored in a computer memory or computer readable storage medium. Optional operations are indicated by dashed lines (e.g., boxes with dashed-line borders). In some implementations, the method described in FIG. 13 is performed by the media management server system (FIG. 1, 120).

In some implementations the method is performed at a computer system including one or more processors and memory storing one or more programs for execution by the one or more processors, wherein the computer system hosts a media management system. In some implementations the media management server system (FIG. 1, 120) receives (1302) one or more art creation steps {e.g., brush strokes from a painter, mouse clicks and mouse strokes, finger touches and swipes, etc.} in real time as they are created from a first client device (e.g., a mobile phone, tablet, personal computer, etc.). In some implementations the first client device has an application installed specifically to transmit the steps of art creation to the media management server system (FIG. 1, 120). For example, Child A wants to create drawing. He or she opens a specific art creation application on tablet computer with a touch screen. Each touch and stroke by Child A is transmitted to the media management server system (FIG. 1, 120) as it occurs. In some implementations the application on the first client device is registered with a specific display device. For example, Child A's tablet application is registered and connected to a display in his or her mother's office.

In some implementations the media management server system (FIG. 1, 120) transmits (1304) the received one or more art creation steps to a display device for display; wherein the display device is at a distinct location from the first client device. For example, the media management server system (FIG. 1, 120) transmits Child A's creation steps to the display in his or her father's office so the mother can watch the artwork as the child creates. In some implementations the specific art creation steps are saved for later playback.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

What is claimed is:

1. A computer-implemented method comprising:
at a computer system including one or more processors and memory storing one or more programs for execution by the one or more processors, wherein the computer system hosts a media management system:
receiving a selection message from a mobile computing device associated with a user of the media management system, wherein the selection message identifies a selected media content item and an intended display device; and
transmitting the selected media content item to a physical display device associated with the media management system for presentation.

2. The method of claim 1, wherein a media content item is one of an image, a video, text configured for display, an animation, or an audio recording.

3. The method of claim 1, wherein the physical display device is distinct from the mobile device associated with the first user.

4. The method of claim 1, wherein the physical display device is associated with a second user of the media management system.

5. The method of claim 1, wherein the physical display device is a digital picture frame.

6. The method of claim 1, wherein the picture frame is an e-paper display.

7. The method of claim 4, further including, prior to receiving the selection message, receiving user access rules for the physical display device associated with to second user from the second user.

8. The method of claim 7, further including, after receiving the selection message from the first user:
determining whether the first user is authorized to change the media content item presented at the intended display device based on the user access rules received from the second user; and
in response to determining that the first user is not authorized to change the media content item presented at the intended display device, sending a notification to the first user indicating that the select media content item will not presented at the intended display device.

9. The method of claim 7, further including, after receiving the selection message from the first user:
determining whether the user access rules received from the second user allow the selected media content item to be presented at the intended display device; and
in response to determining that the user access rules do not allow the selected media content item to be presented at the intended display device, sending a notification to the first user indicating that the select media content item will not presented at the intended display device.

10. The method of claim 1, further including:
storing a plurality of currently displaying values for a plurality of display devices associated with the media management system, wherein a respective currently displaying value identifies a media content item currently displayed at a respective associated display device; and
after sending the selected media content item to the intended display device for presentation, updating the currently displaying value for the intended display device to reflect the selected media content item.

11. The method of claim 1, further including, prior to receiving the selection message:
for each respective display device in the plurality of display devices associated with the media management system:
determining whether the first user is authorized to change the presented media content item at the respective display device; and
in accordance with a determination that the first user is authorized change the presented media content item at the respective display device, identifying the respective display device as an authorized display device for the first user;
transmitting a webpage to the first user; wherein the transmitted webpage includes one or more identified authorized display devices and does not include any display devices that are not authorized display devices for the first user; and
wherein the selected intended display device is selected from the one or more identified authorized display devices included in the transmitted webpage.

12. A system comprising:
one or more processors;
memory; and
one or more programs stored in the memory, the one or more programs comprising instructions for:
receiving a selection message from a mobile computing device associated with a user of the media management system, wherein the selection message identifies a selected media content item and an intended display device; and
transmitting the selected media content item to a physical display device associated with the media management system for presentation.

13. The system of claim 12, wherein the physical display device is associated with a second user of the media management system.

14. The system of claim 13, furthering including instructions for prior to receiving the selection message, receiving user access rules for the physical display device associated with to second user from the second user.

15. The system of claim 14, further including instructions for, after receiving the selection message from the first user:
determining whether the first user is authorized to change the media content item presented at the intended display device based on the user access rules received from the second user; and
in response to determining that the first user is not authorized to change the media content item presented at the intended display device, sending a notification to the first user indicating that the select media content item will not presented at the intended display device.

16. A non-transitory computer readable storage medium storing one or more programs for execution by one or more processors, the one or more programs comprising instructions for:
receiving a selection message from a mobile computing device associated with a user of the media management system, wherein the selection message identifies a selected media content item and an intended display device; and
transmitting the selected media content item to a physical display device associated with the media management system for presentation.

17. The non-transitory computer readable storage medium of claim 16, wherein the physical display device is associated with a second user of the media management system.

18. The non-transitory computer readable storage medium of claim 17, furthering including instructions for prior to receiving the selection message, receiving user access rules for the physical display device associated with to second user from the second user.

19. The non-transitory computer readable storage medium of claim 18, further including instructions for, after receiving the selection message from the first user:
determining whether the first user is authorized to change the media content item presented at the intended display device based on the user access rules received from the second user; and
in response to determining that the first user is not authorized to change the media content item presented at the intended display device, sending a notification to the first user indicating that the select media content item will not presented at the intended display device.

20. The non-transitory computer readable storage medium of claim 16, further including instructions for:
storing a plurality of currently displaying values for a plurality of display devices associated with the media management system, wherein a respective currently displaying value identifies a media content item currently displayed at a respective associated display device; and
after sending the selected media content item to the intended display device for presentation, updating the currently displaying value for the intended display device to reflect the selected media content item.
